(19) United States
(12) Patent Application Publication
(10) Pub. No.: US 2025/0239804 A1
(43) Pub. Date: Jul. 24, 2025

(54) CABLE CONNECTOR

(71) Applicant: TE Connectivity Solutions GmbH, Schaffhausen (CH)

(72) Inventor: Galen M. Martin, Middletown, PA (US)

(21) Appl. No.: 18/416,045

(22) Filed: Jan. 18, 2024

(51) Int. Cl. H01R 13/514; H01R 13/11

(52) U.S. Cl. CPC H01R 13/514; H01R 13/111

(57) ABSTRACT

A cable connector includes a connector housing having a chamber and a carrier opening. Cables are received in the chamber. A cable seal is sealed to the cables and the connector housing. Terminals are held in a terminal carrier and are configured to be terminated to the corresponding cables. Terminating ends of the terminals have insulation displacement contacts configured to be terminated to the corresponding cable. The terminal carrier is coupled to the connector housing at the carrier opening and is loaded into the chamber in a loading direction perpendicular to the longitudinal axis. The terminal carrier presses the terminals in the loading direction to press the insulation displacement contacts of the terminals onto the cables as the terminal carrier is loaded into the chamber in the loading direction.

### BACKGROUND OF THE INVENTION

The subject matter herein relates generally to cable connectors.

Existing cable connectors often present significant obstacles in terms of assembly and cable-to-terminal connections. The assembly process may involve intricate steps, demanding a high level of precision and skill. This complexity can lead to increased manufacturing time and costs, and may introduce a higher likelihood of human error. Additionally, once assembled, conventional connectors may not consistently ensure a secure and stable connection between the cable and the terminal. This vulnerability can lead to signal degradation, intermittent connectivity issues, and potential safety hazards, particularly in high stress environments.

A need remains for a cost effective cable connector having reliable cable to terminal connections.

### BRIEF DESCRIPTION OF THE INVENTION

In one embodiment, a cable connector is provided and includes a connector housing that includes a chamber extending along a longitudinal axis between a front and a rear of the connector housing. The front defines a mating end configured to be mated to a mating connector. The rear defines a cable end. The connector housing includes a carrier opening. The cable connector includes cables received in the chamber and extending from the cable end at the rear of the connector housing. The cable connector includes at least one cable seal sealed to the cables and sealed to the connector housing to provide an environmental seal at the cable end. The cable connector includes terminals configured to be terminated to the corresponding cables in the chamber. Each terminal extends between a mating end and a terminating end. The mating end of the terminal configured to be mated to a mating contact of the mating connector. The terminating end includes an insulation displacement contact configured to be terminated to the corresponding cable. The cable connector includes a terminal carrier having terminal channels to hold the terminals. The terminal carrier includes latching features engaging the terminals to hold the terminals in the terminal channels. The terminal carrier is coupled to the connector housing at the carrier opening. The terminal carrier is loaded into the chamber in a loading direction perpendicular to the longitudinal axis. The terminal carrier presses the terminals in the loading direction to press the insulation displacement contacts of the terminals onto the cables as the terminal carrier is loaded into the chamber in the loading direction.

In another embodiment, a cable connector is provided and includes a connector housing that includes a chamber extending along a longitudinal axis between a front and a rear of the connector housing. The front defines a mating end configured to be mated to a mating connector. The rear defines a cable end. The connector housing includes a carrier opening. The cable connector includes a cable received in the chamber and extends from the cable end at the rear of the connector housing. The cable connector includes a cable seal sealed to the cable and sealed to the connector housing to provide an environmental seal at the cable end. The cable connector includes a terminal configured to be terminated to the cable in the chamber. The terminal extends between a mating end and a terminating end. The mating end of the terminal configured to be mated to a mating contact of the mating connector. The terminating end includes an insulation displacement contact configured to be terminated to the cable. The cable connector includes a terminal carrier that has a terminal channel holding the terminal. The terminal carrier includes a latching feature engaging the terminal to hold the terminal in the terminal channel. The terminal carrier is coupled to the connector housing at the carrier opening. The terminal carrier is loaded into the chamber in a loading direction perpendicular to the longitudinal axis. The terminal carrier presses the insulation displacement contact of the terminal onto the cable as the terminal carrier is loaded into the chamber in the loading direction.

In another embodiment, an electrical connector system is provided and includes a mating connector that includes a mating connector housing holding mating contacts. The mating connector includes a mating connector latching feature. The mating connector housing includes a receptacle. The mating contacts are positioned in the receptacle. The electrical connector system includes a cable connector plugged into the receptacle. The cable connector includes a connector housing that includes a chamber extending along a longitudinal axis between a front and a rear of the connector housing. The front defines a mating end plugged into the receptacle of the mating connector in a mating direction parallel to the longitudinal axis. The rear defines a cable end. The connector housing includes a carrier opening. The connector housing includes a latching feature engaging the mating connector latching feature to secure the connector housing to the mating connector housing. The cable connector includes cables received in the chamber and extends from the cable end at the rear of the connector housing. The cable connector includes at least one cable seal sealed to the cables and sealed to the connector housing to provide an environmental seal at the cable end. The cable connector includes terminals configured to be terminated to the corresponding cables in the chamber. Each terminal extends between a mating end and a terminating end. The mating end of the terminal mated to the corresponding mating contact of the mating connector. The terminating end includes an insulation displacement contact configured to be terminated to the corresponding cable. The cable connector includes a terminal carrier that has terminal channels holding the terminals. The terminal carrier includes latching features engaging the terminals to hold the terminals in the terminal channels. The terminal carrier is coupled to the connector housing at the carrier opening. The terminal carrier is loaded into the chamber in a loading direction perpendicular to the longitudinal axis. The terminal carrier pressing the terminals in the loading direction to press the insulation displacement contacts of the terminals onto the cables as the terminal carrier is loaded into the chamber in the loading direction.

### BRIEF DESCRIPTION OF THE DRAWINGS

FIG. 1 is a perspective view of an electrical connector system in accordance with an exemplary embodiment.

FIG. 2 is a sectional view of the electrical connector system in accordance with an exemplary embodiment.

FIG. 3 is a side perspective view of the terminal in accordance with an exemplary embodiment.

FIG. 4 is a top perspective view of the terminal in accordance with an exemplary embodiment.

FIG. 5 is a bottom perspective, partial sectional view of a portion of the cable connector in accordance with an exemplary embodiment showing the cable connector at an initial stage of assembly.

FIG. 6 is a bottom perspective, partial sectional view of a portion of the cable connector showing the cable connector at an intermediate stage of assembly in accordance with an exemplary embodiment.

FIG. 7 is a top perspective, partial sectional view of a portion of the cable connector showing the cable connector at the intermediate stage of assembly in accordance with an exemplary embodiment.

FIG. 8 is a bottom perspective, partial sectional view of a portion of the cable connector showing the cable connector at a final stage of assembly in accordance with an exemplary embodiment.

FIG. 9 is a bottom perspective of the cable connector in accordance with an exemplary embodiment showing the cable connector at an initial stage of assembly.

FIG. 10 is a bottom perspective view of the cable connector showing the cable connector at a final stage of assembly.

### DETAILED DESCRIPTION OF THE INVENTION

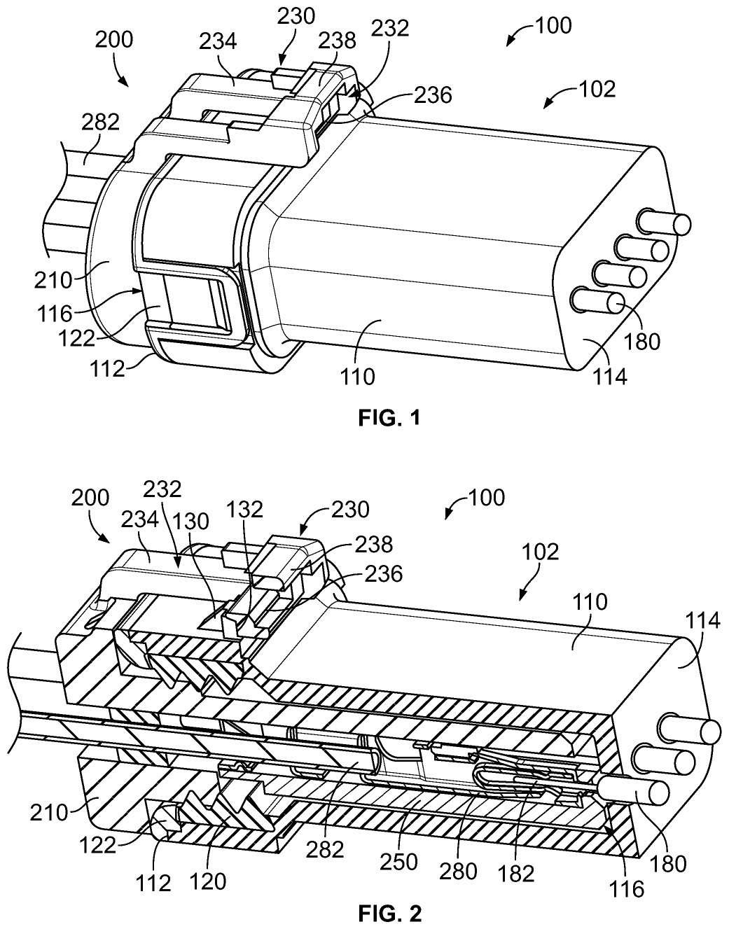

FIG. 1 is a perspective view of an electrical connector system 100 in accordance with an exemplary embodiment. FIG. 2 is a sectional view of the electrical connector system 100 in accordance with an exemplary embodiment. The electrical connector system 100 includes a cable connector 200 and a mating connector 102. The cable connector 200 is connected to the mating connector 102 to electrically connect various components of the electrical connector system 100. In an exemplary embodiment, the electrical connector system 100 is an automotive connector system configured to be used within an automotive vehicle. However, the electrical connector system 100 may be used in other applications in alternative embodiments, such as other types of vehicles. In other various embodiments, the electrical connector system 100 may be used in an appliance or and industrial application. In other various embodiments, the electrical connector system 100 may be used in a computer system, such as a network device.

In various embodiments, the mating connector 102 is a board connector configured to be mounted to a circuit board (not shown). In other various embodiments, the mating connector 102 is a cable connector configured to be mounted to ends of one or more cables (not shown). In the illustrated embodiment, the mating connector 102 is a receptacle connector and the cable connector 200 is configured to be plugged into the receptacle of the mating connector 102. However, in alternative embodiments, the mating connector 102 may be a plug connector. In various embodiments, the mating connector 102 may be a header connector configured to be mounted to a component.

In an exemplary embodiment, the mating connector 102 includes a mating connector housing 110 extending between a front 112 and a rear 114. The mating connector housing 110 includes a receptacle 116 which may be open at the front 112 and/or the rear 114. The receptacle 116 receives the cable connector 200. In the illustrated embodiment, the front 112 defines a mating end of the mating connector 102. The cable connector 200 is plugged into the receptacle 116 at the mating end through an opening at the front 112. The rear 114 may be mounted to another component, such as a device or chassis of the vehicle. Optionally, the rear 114 may be mounted to a circuit board. In other various embodiments, one or more cables may extend from the rear 114.

In an exemplary embodiment, the mating connector 102 includes one or more mating contacts 180, which are configured to be mated with corresponding terminals of the cable connector 200. The mating contacts 180 may be held by the mating connector housing 110. For example, the mating contacts 180 may be held by the rear wall of the mating connector housing 110. In the illustrated embodiment, the mating contacts 180 include pins 182 at mating ends of the mating contacts 180. Other types of contacts may be used in alternative embodiments, such as sockets, spring beams, blades, split beam contacts, and the like. The opposite ends of the mating contacts 180 may be terminated to a circuit board or may be terminated to corresponding cables depending on the particular application.

In an exemplary embodiment, the mating connector 102 includes a connector seal 120 configured to be sealed between the mating connector housing 110 and the cable connector 200. The connector seal 120 provide a sealed interface between the mating connector 102 and the cable connector 200. In the illustrated embodiment, the connector seal 120 is held in the receptacle 116. For example, a seal retainer 122 may be coupled to the front 112 to hold the connector seal 120 in the receptacle 116.

In an exemplary embodiment, the mating connector 102 includes a latching feature 130 used to secure the cable connector 200 to the mating connector 102. In the illustrated embodiment, the latching feature 130 includes a fixed latch 132 provided at an exterior of the mating connector housing 110, such as at a top of the mating connector housing 110. The fixed latch 132 includes a latching surface configured to be engaged by the cable connector 200 to latchably secure the cable connector 200 to the mating connector 102. Other types of securing features may be used in alternative embodiments, such as fasteners, clips, and the like.

The cable connector 200 includes a connector housing 210 and a terminal carrier 250 holding one or more terminals 280, which are configured to be mated with the mating contacts 180 of the mating connector 102. In an exemplary embodiment, the connector housing 210 in the terminal carrier 250 holds a plurality of the terminals 280 to form multiple communication lines between the cable connector 200 and the mating connector 102. In an exemplary embodiment, the terminals 280 are terminated to ends of corresponding cables 282. In an exemplary embodiment, the terminals 280 are terminated to the cables 282 during assembly of the terminal carrier 250 with the connector housing 210. For example, the terminal carrier 250 is configured to be mated to the connector housing 210 and the terminals 280 are terminated to the cables 282 when the terminal carrier 250 is mated to the connector housing 210. In an exemplary embodiment, all of the terminals 280 are simultaneously terminated to the corresponding cables 282 when the terminal carrier 250 is mated to the connector housing 210.

In an exemplary embodiment, the cable connector 200 includes a latching feature 230 configured to be latchably coupled to the latching feature 130 of the mating connector 102. In the illustrated embodiment, the latching feature 230 includes a deflectable latch 232 having a latch arm 234 and a latching beam extending from the latch arm 234. The latching beam 236 engages the fixed latch 132 to secure the cable connector 200 to the mating connector 102. In an exemplary embodiment, the latching feature 230 includes a release element 238 used to release the latching beam 236 from the fixed latch 132. The release element 238 may be a tab or tether that may be pushed or pulled in a releasing direction to release the latching beam 236. In the illustrated embodiment, the latching feature 230 is provided at the top of the connector housing 210. However, other locations are possible in alternative embodiments. Other types of securing features may be used in alternative embodiments to secure the cable connector 200 to the mating connector 102, such as fasteners, clips, and the like.

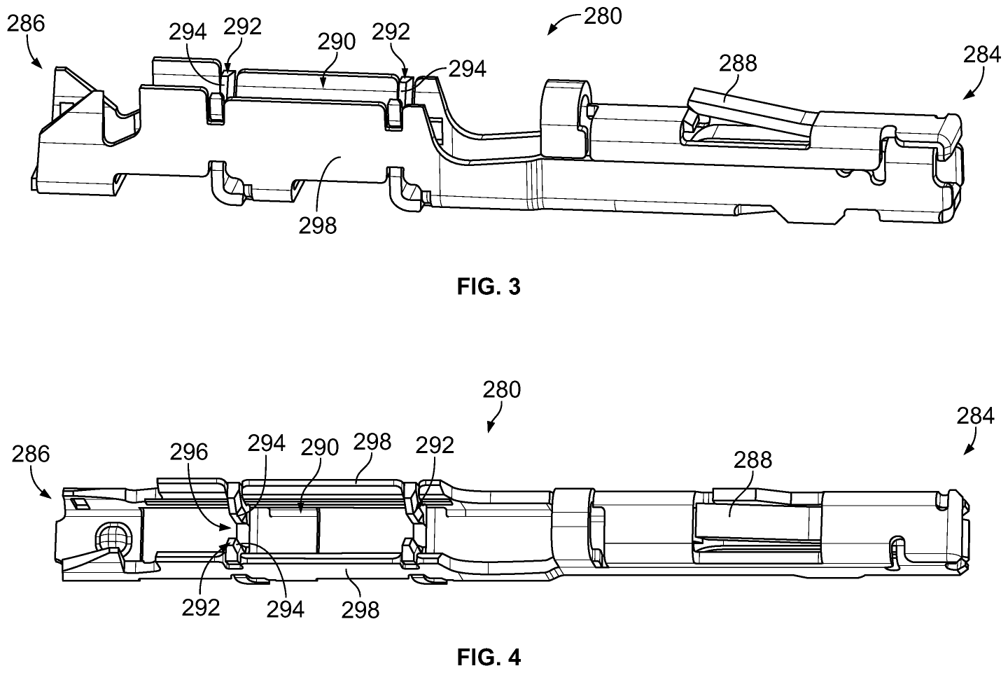

FIG. 3 is a side perspective view of the terminal 280 in accordance with an exemplary embodiment. FIG. 4 is a top perspective view of the terminal 280 in accordance with an exemplary embodiment. In an exemplary embodiment, the terminal 280 is a stamped and formed terminal that is stamped from a metal sheet of material and formed into a predetermined shape. The terminal 280 is manufactured from a conductive material, such as a metal material. The terminal 280 may be manufactured from a copper or copper alloy or aluminum or an aluminum alloy or stainless steel. Optionally, portions of the terminal 280 may be coated or plated to improve characteristics of the terminal 280, such as conductivity, wear, and the like.

The terminal 280 extends between a mating end 284 and a terminating end 286. The terminal 280 extends longitudinally along a terminal axis between a front and a rear of the terminal 280. The mating end 284 is provided at the front of the terminal 280 and the terminating end 286 is provided at the rear of the terminal 280. The terminal 280 may have other shapes in alternative embodiments, such as being a right angle terminal.

The mating end 284 is configured to be mated to the mating contact 180 of the mating connector 102 (FIG. 1). In an exemplary embodiment, the mating end 284 includes a socket configured to receive the pin 182 of the mating contact 180. However, other types of contacts may be used in alternative embodiments, such as a pin, a spring beam, a blade, and the like. In an exemplary embodiment, the terminal 280 includes a locking feature 288 used to secure the terminal 280 in the connector housing 210 (FIG. 2). In the illustrated embodiment, the locking feature 288 includes a or bar is bent outward from the main body of the terminal 280. The locking feature 288 is configured to spring outward into a pocket or recessed in the connector housing 210 to secure the terminal 280 in the connector housing 210. Other types of securing features may be used in alternative embodiments to secure the terminal 280 in the connector housing 210.

The terminating end 286 is configured to be terminated to the cable 282 (FIG. 1). In an exemplary embodiment, the terminal 280 includes a cable pocket 290 at the terminating end 286 that receives the cable 282. In an exemplary embodiment, the terminal 280 includes one or more insulation displacement contacts 292 in the cable pocket 290. In the illustrated embodiment, the terminal 280 includes a pair of the insulation displacement contacts 292 however, the terminal 280 may include greater or fewer insulation displacement contacts 292 in alternative embodiments. Each insulation displacement contact 292 includes opposed cutting elements 294 on opposite sides of a gap 296. When the cable 282 is pressed into the gap 296, the cutting elements 294 pierce the insulation of the cable 282 to electrically connect to a center conductor of the cable 282 the cutting elements 294 may include lead-in surfaces to guide the cable into the gap 296. The cutting elements 294 extend inward from opposite side walls 298 of the terminal 280. The cable pocket 290 is defined between the side walls 298. In an exemplary embodiment, a top of the terminal 280 is open along the cable pocket 290 to receive the cable 282.

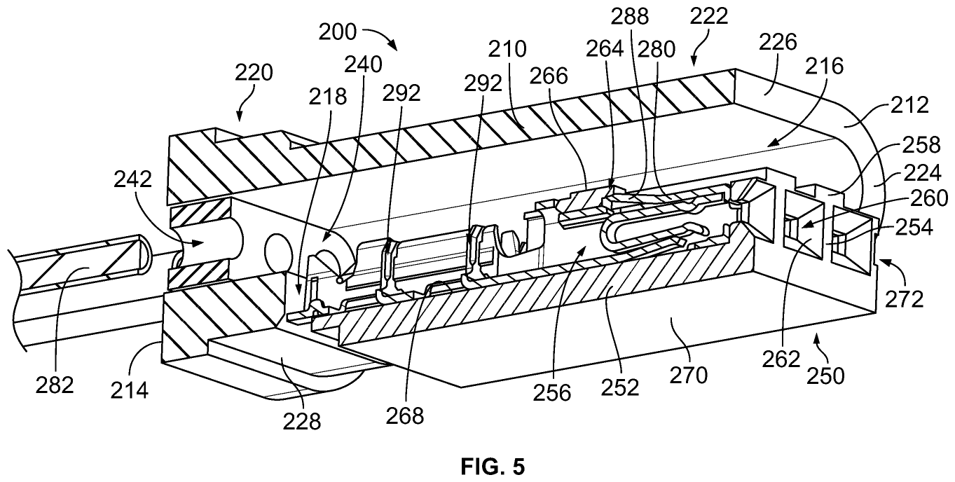

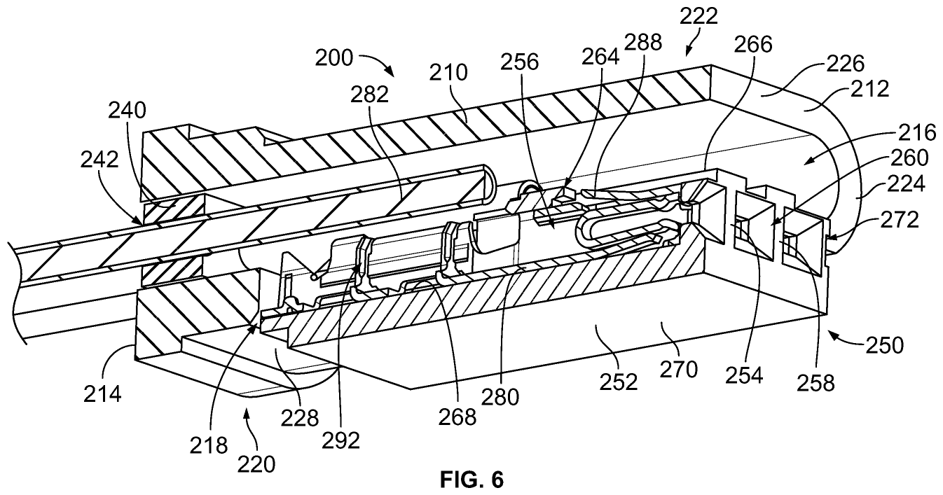

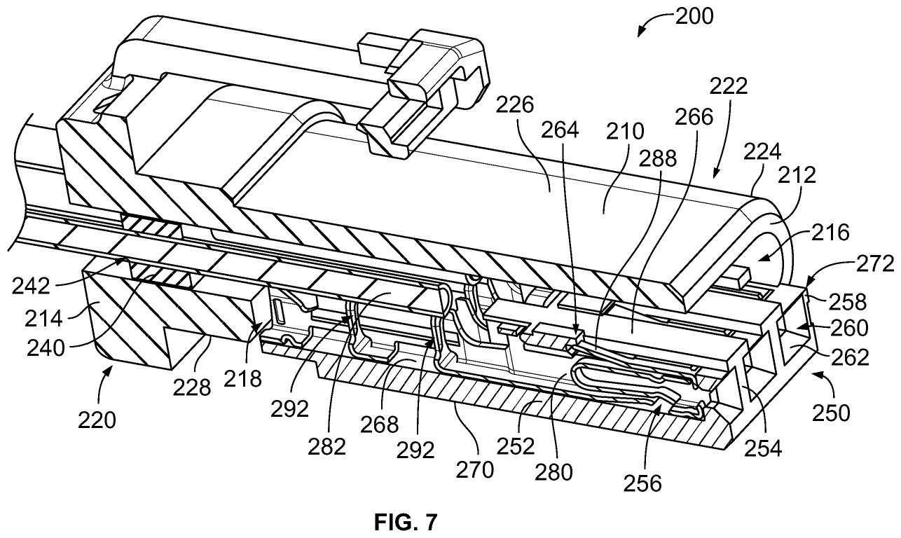

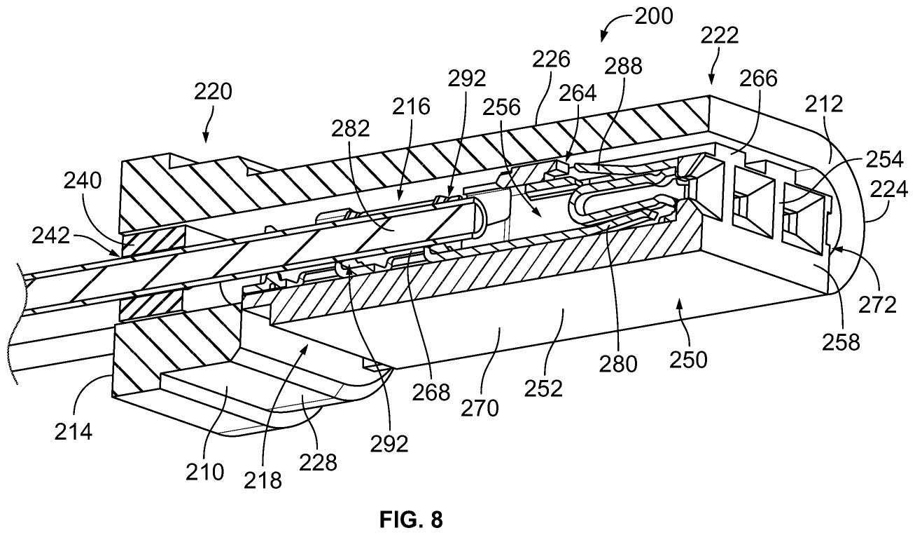

FIG. 5 is a bottom perspective, partial sectional view of a portion of the cable connector 200 in accordance with an exemplary embodiment showing the cable connector 200 at an initial stage of assembly. FIG. 6 is a bottom perspective, partial sectional view of a portion of the cable connector 200 showing the cable connector 200 at an intermediate stage of assembly. FIG. 7 is a top perspective, partial sectional view of a portion of the cable connector 200 showing the cable connector 200 at the intermediate stage of assembly. FIG. 8 is a bottom perspective, partial sectional view of a portion of the cable connector 200 showing the cable connector 200 at a final stage of assembly.

At the initial stage of assembly (FIG. 5), the terminals 280 are arranged in the terminal carrier 250 in the terminal carrier 250 is initially coupled to the connector housing 210 and is located at an extended position. The cables 282 are shown poised for loading into the connector housing 210 at the initial stage of assembly (FIG. 5). At the intermediate stage of assembly (FIGS. 6 and 7), the cables 282 are loaded into the connector housing 210 and positioned relative to the terminals 280 for termination of the terminals 280 to the cables 282. At the final stage of assembly (FIG. 8), the terminal carrier 250 is moved to a retracted position into the connector housing 210 to terminate the terminals 280 to the cables 282.

The connector housing 210 extends between a front 212 and a rear 214. The connector housing 210 includes a chamber 216 extending along a longitudinal axis between the front 212 and the rear 214. The connector housing 210 includes a carrier opening 218 that is open to the chamber 216. The terminal carrier 250 is received in the carrier opening 218. The front 212 defines a mating end of the cable connector 200 configured to be mated with the mating connector 102 (FIG. 1). The rear 214 defines a cable end of the cable connector 200. The cables 282 extend from the cable end. In an exemplary embodiment, the connector housing 210 includes a base 220 at the rear 214 and a shroud 222 extending forward from the base 220 to the front 212. The shroud 222 covers the terminals 280. In an exemplary embodiment, the base 220 is an enlarged relative to the shroud 222. For example, a height and/or a width of the base 220 may be larger than the shroud 222. For example, the connector housing 210 may be stepped outward at the base 220.

In an exemplary embodiment, the connector housing 210 includes sides 224 extending between a top 226 and the bottom 228 of the connector housing 210. In the illustrated embodiment, the carrier opening 218 is provided at the bottom 228. Other locations are possible in alternative embodiments. In the illustrated embodiment, the bottom 228 of the connector housing 210 along the shroud 222 is completely open, defining the carrier opening 218, to receive the terminal carrier 250. The sides 224 and the top 226 of the shroud 222 surround the chamber 216 along the front portion of the connector housing 210. In an exemplary embodiment, the base 220 entirely surrounds the chamber 216 at the rear portion of the connector housing 210. For example, the base 220 is continuous along the top 226, the bottom 228, and both sides 224. In an exemplary embodiment, the connector housing 210 is oval-shaped, wherein the sides 224 are curved or grounded between the top 226 and the bottom 228. In the illustrated embodiment, the top 226 and the bottom 228 are generally planar and parallel to each other. Other shapes are possible in alternative embodiments. For example, the sides 224 may be squared relative to the top 226 and the bottom 228 being parallel to each other and perpendicular to the top 226 and the bottom 228. In other alternative embodiments, the top 226 and/or the bottom 228 may be curved rather than being planar. The chamber 216 is elongated, side to side, to accommodate multiple terminals 280, such as in a single row.

In an exemplary embodiment, the cable connector 200 includes one or more cable seals 240 received in the chamber 216. The cable seal 240 may be provided at the rear 214. The cables 282 are configured to pass through the cable seal 240 into the chamber 216. In the illustrated embodiment, a single cable seal 240 is provided, configured to receive multiple cables 282 through openings 242 in the cable seal 240. However, in alternative embodiments, multiple individual cable seals 240 may be provided, each configured to receive a corresponding one of the cables 282. The cable seal 240 is configured to seal to the cable(s) 282. The cable seal 240 is configured to be sealed to the connector housing 210. For example, an exterior surface of the cable seal 240 engages the connector housing 210 in the chamber 216 to seal the cable end of the housing 210. In various embodiments, the cable seal 240 is manufactured from a rubber material. The cable seal 240 may be configured to provide a watertight seal to the cable 282 and/or the connector housing 210.

The terminal carrier 250 is used to carry the terminals 280 and hold the terminals 280 within the connector housing 210. The terminal carrier 250 is used to terminate the terminals 280 to the cables 282. For example, when the terminal carrier 250 is assembled to the connector housing 210, the terminals 280 are pushed onto the cables 282 to electrically connect the insulation displacement contacts 292 to the cables 282.

In an exemplary embodiment, the terminal carrier 250 includes a platform used to support the terminals 280 and separating walls 254 used to position the terminals 280 on the platform 252. The separating walls 254 and the platform 252 form terminal channels 256 that hold the terminals 280. In an exemplary embodiment, the terminal carrier 250 includes a front wall 258 at a front of the terminal carrier 250. The front wall 258 includes ports 260 that open to the terminal channels 256. The ports 260 have guide walls 262 that guide the mating contacts 180 into the sockets of the terminals 280 during mating. The guide walls 262 may provide vertical and/or horizontal guidance for the mating contacts 180. In an exemplary embodiment, the terminal carrier 250 includes a latching feature 264 used to secure the terminal 280 in the terminal channels 256. In the illustrated embodiment, the latching feature 264 includes a pocket configured to receive the locking feature 288 of the terminal 280. Other types of securing features may be used in alternative embodiments to secure the terminal 280 in the terminal channel 256. In the illustrated embodiment, the latching feature 264 is provided and an upper wall 266 above the terminal channels 256. The platform 252 includes an upper surface that supports the terminal 280. The terminal 280 is seated on the upper surface 268. The platform 252 includes a bottom 270 opposite the upper surface 268. In an exemplary embodiment, the terminal carrier 250 may include securing features 272 at opposite sides of the terminal carrier 250 the securing features 272 are used to secure the terminal carrier 250 to the connector housing 210. The securing features 272 may include slots, grooves, rails, tabs, or other features used to interface with the connector housing 210 to hold the terminal carrier 250 at one or more positions relative to the connector housing 210. In an exemplary embodiment, multiple securing features 272 are provided that hold the terminal carrier 250 at different vertical positions relative to the connector housing 210.

During assembly, the terminals 280 are loaded into the corresponding terminal channels 256 in the terminal carrier 250. In an exemplary embodiment, a plurality of the terminals 280 are arranged in the terminal carrier 250, such as in a single row along the platform 252. Any number of terminals 280 may be provided. Optionally, the terminals 280 may be rear loaded into the terminal channels 256. The locking features 288 may interface with the latching features 264 of the terminal carrier 250 to secure the terminals 280 in the terminal channels 256. The sockets of the terminals 280 are aligned with the ports 260 to receive the mating contacts 180.

The terminal carrier 250 is initially connected to the connector housing 210 and held in an extended position (FIG. 5). The terminal carrier 250 is movable relative to the connector housing 210 between the extended position (FIG. 5) and the retracted position (FIG. 8). For example, the terminal carrier 250 is movable in a vertical direction, for example upward, from the extended position to the retracted position. The terminal carrier 250 is pushed inward into the connector housing 210 from the extended position to the retracted position. In the extended position, the bulk of the terminal carrier 250 and the terminals 280 are located outside of the chamber 216, such as below the bottom of the connector housing 210. A space is provided in the chamber 216 above the terminal carrier 250 and the terminals 280 when the terminal carrier 250 is in the extended position. The space is provided to allow the cables 282 to be loaded into the chamber 216.

During assembly, the cables 282 are loaded into the connector housing 210, such as through the rear 214. The cables 282 are loaded through the openings 242 in the cable seal 240. Optionally, the cable seal 240 may be pre-positioned in the connector housing 210 prior to loading the cables 282 into the connector housing 210. In alternative embodiments, the plurality of the cables 282 may be loaded into the cable seal 240 prior to loading the cable seal 240, with the cables 282, into the connector housing 210. The cables 282 extend forward of the cable seal 240 into the chamber 216. The cables 282 are held in positions located vertically above the corresponding terminals 280. The cables 282 are located above the terminals 280 and the terminal carrier 250. The cables 282 may be cantilevered from the cable seal 240. Optionally, the connector housing 210 may include features to position the cables 282 in the chamber 216.

After the cables 282 are positioned in the chamber 216, the terminal carrier 250 may be loaded into the connector housing 210 to terminate the terminals 280 to the cables 282. For example, the terminal carrier 250 may be pressed vertically upward into the chamber 216 to press the insulation displacement contacts 292 onto the cables 282. The terminal carrier 250 is coupled to the connector housing 210 at the carrier opening 218 and is loaded into the chamber 216 in a loading direction that is perpendicular to the longitudinal axis of the connector housing 210. The terminal carrier 250 presses the terminals 280 in the loading direction to press the insulation displacement contacts 292 onto the cables 282 as the terminal carrier 250 is loaded into the chamber 216 in the loading direction. The insulation displacement contacts 292 pierce the jackets of the cables 282 to electrically connect to the center conductors of the cables 282. In an exemplary embodiment, each of the terminals 280 includes multiple insulation displacement contacts 292 arranged coaxially along the terminal 280 to interface with the cables 282 at different axial positions. As such, a robust electrical connection is made between the cables 282 and the terminals 280. In an exemplary embodiment, the terminal carrier 250 holds all of the terminals 280 such that all of the terminals 280 are simultaneously connected to the cables 282 when the terminal carrier 250 is pressed into the connector housing 210 from the extended position to the retracted position. The terminal carrier 250 is used for mass termination of the plurality of the terminals 280 to the corresponding cables 282 by pressing the terminal carrier 250 into the final position within the connector housing 210. Each of the cables 282 are held stationary, and remain sealed, during loading of the terminal carrier 250 into the connector housing 210. Optionally, a single cable seal 240 may be used for the plurality of terminals 280 because the terminals 280 are terminated to the cables 282 after the cables 282 are loaded in the connector housing 210. A robust sealed interface is provided between the cables 282 8 and the connector housing 210.

The terminals 280 are loaded into the chamber 216 in the loading direction when the terminal carrier 250 is moved from the extended position to the retracted position. In an exemplary embodiment, when the terminal carrier 250 is loaded into the connector housing 210, the bottom 270 of the platform 252 of the terminal carrier 250 is flush with the bottom 228 of the connector housing 210. The shroud 222 and the platform 252 form a continuous housing structure around the chamber 216 to surround the terminals 280. The sides 224 of the shroud 222 connect the top 226 of the shroud 222 and the platform 252. When assembled, the shroud 222 of the connector housing 210 and the terminal carrier 250 are configured to be plugged into the receptacle 116 of the mating connector housing 110 (FIG. 2).

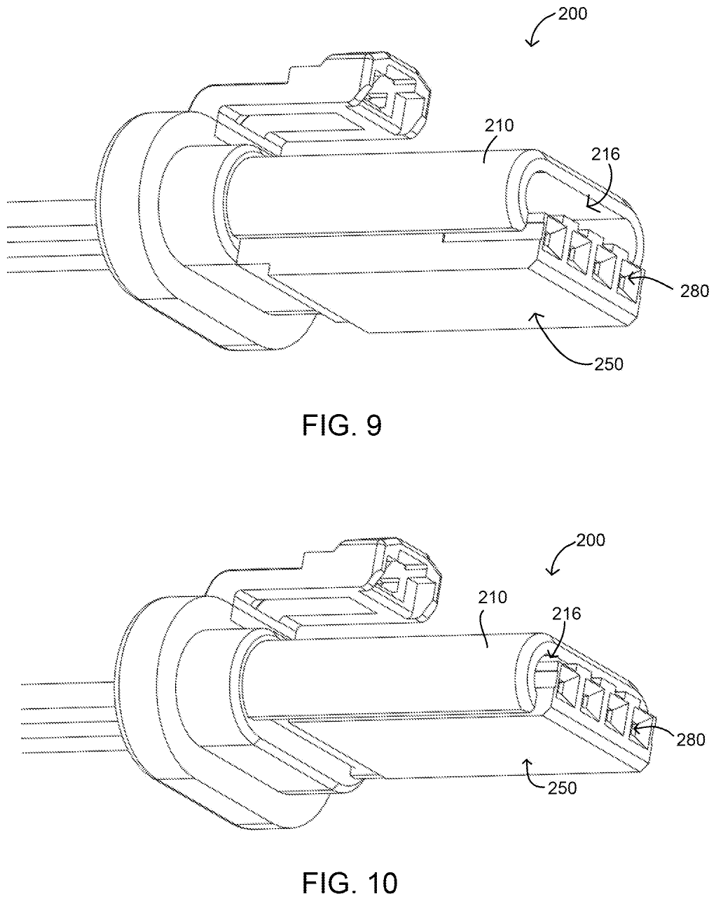

FIG. 9 is a bottom perspective of the cable connector 200 in accordance with an exemplary embodiment showing the cable connector 200 at an initial stage of assembly. FIG. 10 is a bottom perspective view of the cable connector 200 showing the cable connector 200 at a final stage of assembly.

At the initial stage of assembly (FIG. 9), the terminals 280 and the terminal carrier 250 are located at an extended position. At the final stage of assembly (FIG. 10), the terminal carrier 250 is moved to a retracted position into the connector housing 210 to terminate the terminals 280 to the cables 282. For example, the terminal carrier 250 is movable in a vertical direction, for example upward, from the extended position to the retracted position. The terminal carrier 250 is pushed inward into the connector housing 210 from the extended position to the retracted position. The terminal carrier 250 may be pressed vertically upward into the chamber 216 to press the insulation displacement contacts 292 onto the cables 282. The insulation displacement contacts 292 pierce the jackets of the cables 282 to electrically connect to the center conductors of the cables 282.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

What is claimed is:

1. A cable connector comprising:
a connector housing including a chamber extending along a longitudinal axis between a front and a rear of the connector housing, the front defining a mating end configured to be mated to a mating connector, the rear defining a cable end, the connector housing including a carrier opening;
cables received in the chamber and extending from the cable end at the rear of the connector housing;
at least one cable seal sealed to the cables and sealed to the connector housing to provide an environmental seal at the cable end;
terminals configured to be terminated to the corresponding cables in the chamber, each terminal extending between a mating end and a terminating end, the mating end of the terminal configured to be mated to a mating contact of the mating connector, the terminating end including an insulation displacement contact configured to be terminated to the corresponding cable; and
a terminal carrier having terminal channels holding the terminals, the terminal carrier including latching features engaging the terminals to hold the terminals in the terminal channels, the terminal carrier being coupled to the connector housing at the carrier opening;
wherein the terminal carrier is loaded into the chamber in a loading direction perpendicular to the longitudinal axis, the terminal carrier pressing the terminals in the loading direction to press the insulation displacement contacts of the terminals onto the cables as the terminal carrier is loaded into the chamber in the loading direction.

2. The cable connector of claim 1, wherein each of the terminals are simultaneously connected to the corresponding cables when the terminal carrier is loaded into the chamber.

3. The cable connector of claim 1, wherein the cables are positioned in the chamber prior to connecting the terminals to the cables.

4. The cable connector of claim 1, wherein the terminal carrier is separate and discrete from the connector housing, the terminal carrier being movable relative to the connector housing, the terminal carrier being coupled to the connector housing to position the terminals relative to the connector housing.

5. The cable connector of claim 1, wherein the terminal carrier carries the terminals from unterminated positions to terminated positions, the terminals being terminated to the cables in the terminated positions.

6. The cable connector of claim 1, wherein the terminal carrier includes separating walls between the terminal channels, the separating walls positioning the terminals relative to each other.

7. The cable connector of claim 1, wherein the terminals are arranged parallel to each other in a single row.

8. The cable connector of claim 1, wherein the terminal carrier includes a platform at a bottom of the terminal carrier, the platform supporting the terminals on an upper surface of the platform, the platform positioned in the carrier opening when loaded in the loading direction to form a continuous shroud with the connector housing around the chamber.

9. The cable connector of claim 1, wherein each cable extends along a cable axis parallel to the longitudinal axis, each terminal extends along a terminal axis parallel to the longitudinal axis, the terminals pressed onto the cables in the loading direction perpendicular to the cable axis and the terminal axis.

10. The cable connector of claim 1, wherein the carrier opening is at a bottom of the connector housing, the terminal carrier including a bottom, the bottom of the terminal carrier generally flush with the bottom of the connector housing with the terminal carrier is loaded into the chamber.

11. The cable connector of claim 1, wherein the terminal carrier is movable between an extended position and a retracted position, the terminals being located below the chamber in the extended position, the terminals located in the chamber in the retracted position.

12. The cable connector of claim 1, wherein each terminal includes a second insulation displacement contact configured to be terminated to the corresponding cable.

13. The cable connector of claim 1, wherein the at least one cable seal supports the cables forward of the at least one cable seal for mating with the corresponding terminals.

14. A cable connector comprising:
a connector housing including a chamber extending along a longitudinal axis between a front and a rear of the connector housing, the front defining a mating end configured to be mated to a mating connector, the rear defining a cable end, the connector housing including a carrier opening;
a cable received in the chamber and extending from the cable end at the rear of the connector housing;
a cable seal sealed to the cable and sealed to the connector housing to provide an environmental seal at the cable end;
a terminal configured to be terminated to the cable in the chamber, the terminal extending between a mating end and a terminating end, the mating end of the terminal configured to be mated to a mating contact of the mating connector, the terminating end including an insulation displacement contact configured to be terminated to the cable; and
a terminal carrier having a terminal channel holding the terminal, the terminal carrier including a latching feature engaging the terminal to hold the terminal in the terminal channel, the terminal carrier being coupled to the connector housing at the carrier opening;
wherein the terminal carrier is loaded into the chamber in a loading direction perpendicular to the longitudinal axis, the terminal carrier pressing the insulation displacement contact of the terminal onto the cable as the terminal carrier is loaded into the chamber in the loading direction.

15. The cable connector of claim 14, wherein the cable is positioned in the chamber prior to connecting the terminal to the cable.

16. The cable connector of claim 14, wherein the terminal carrier is separate and discrete from the connector housing, the terminal carrier being movable relative to the connector housing, the terminal carrier being coupled to the connector housing to position the terminal relative to the connector housing.

17. An electrical connector system comprising:
a mating connector including a mating connector housing holding mating contacts, the mating connector including a mating connector latching feature, the mating connector housing including a receptacle, the mating contacts positioned in the receptacle; and
a cable connector plugged into the receptacle, the cable connector comprising:
a connector housing including a chamber extending along a longitudinal axis between a front and a rear of the connector housing, the front defining a mating end plugged into the receptacle of the mating connector in a mating direction parallel to the longitudinal axis, the rear defining a cable end, the connector housing including a carrier opening, the connector housing including a latching feature engaging the mating connector latching feature to secure the connector housing to the mating connector housing;
cables received in the chamber and extending from the cable end at the rear of the connector housing;
at least one cable seal sealed to the cables and sealed to the connector housing to provide an environmental seal at the cable end;
terminals configured to be terminated to the corresponding cables in the chamber, each terminal extending between a mating end and a terminating end, the mating end of the terminal mated to the corresponding mating contact of the mating connector, the terminating end including an insulation displacement contact configured to be terminated to the corresponding cable; and
a terminal carrier having terminal channels holding the terminals, the terminal carrier including latching features engaging the terminals to hold the terminals in the terminal channels, the terminal carrier being coupled to the connector housing at the carrier opening;
wherein the terminal carrier is loaded into the chamber in a loading direction perpendicular to the longitudinal axis, the terminal carrier pressing the terminals in the loading direction to press the insulation displacement contacts of the terminals onto the cables as the terminal carrier is loaded into the chamber in the loading direction.

18. The electrical connector system of claim 17, further comprising a connector seal between the mating connector housing and the connector housing.

19. The electrical connector system of claim 17, wherein the mating contacts include pins and the terminals include sockets at the mating ends thereof configured to receive the pins of the mating contacts.

20. The electrical connector system of claim 17, wherein the mating connector housing surrounds the connector housing in the terminal carrier to hold the terminal carrier in the carrier opening of the connector housing when the cable connector is plugged into the receptacle.
